(19) United States
(12) Patent Application Publication
(10) Pub. No.: US 2013/0164134 A1
(43) Pub. Date: Jun. 27, 2013

(54) Limited Yaw Wind Turbine

(71) Applicant: Leonid Goldstein, Agoura Hills, CA (US)

(72) Inventor: Leonid Goldstein, Agoura Hills, CA (US)

(21) Appl. No.: 13/716,756

(22) Filed: Dec. 17, 2012

Related U.S. Application Data
(60) Provisional application No. 61/580,114, filed on Dec. 23, 2011.

(51) Int. Cl. F03D 11/04; F03D 1/00

(52) U.S. Cl. CPC F03D 11/04; F03D 1/001
USPC 416/140; 52/745.15

(57) ABSTRACT

Downwind wind turbine with limited yaw, held by guy wires (105) attached to the top of turbine's tower (101), as well as a method of its deployment.

### BACKGROUND OF THE INVENTION

Horizontal axis wind turbines are usually constructed with a tower and a nacelle on top of it. The nacelle is capable of rotating 360 degrees in horizontal plane (yawing). The rotor is attached to the nacelle. The tower is made to withstand full wind pressure on the rotor from any direction. The tower has to be very strong, because it is subject to the bending forces. Attempts were made to use guy wires to resist some of the wind pressure. Obviously, guy wires cannot be simply attached near the top of the tower because of the rotating blades (the rotor). U.S. Pat. Nos. 4,366,387 and 6,327,957 by Carter describe a wind turbine with a downwind rotor and guy wire attachments below or slightly above the lower edge of the rotor circle. The shortcomings of this approach are that this can work only with relatively short turbine blades (creating a small diameter rotor), and the tower part above the guy wires attachment still needs to resist full wind pressure. This idea, with all the shortcomings, was taken to extremes in U.S. Pat. No. 5,062,765 by McConachy. Another approach was taken in U.S. patent application Ser. No. 12/528,707 by Nygaard et al. It suggests using wires, anchored in the ground and sliding along the tower in such a way that they get out of the way of rotating blades of the downwind rotor. This adds costs and decreases reliability and durability of the construction. U.S. Pat. No. 7,683,498 by Stommel teaches use of wires, anchored at the ground, that can be stressed or unstressed, but the wires are stressed only when the blades are stopped, i.e., when the rotor does not experience significant load. This makes the apparatus useless when the wind turbine operates.

This invention is directed to solving the problem of resisting wind pressure, acting on the rotor of a wind turbine.

### SUMMARY OF THE INVENTION

The invention is directed toward a wind turbine with a limited yaw, a light weight tower for a wind turbine, a method of wind turbine deployment and more.

Many sites for wind turbine have highly asymmetric wind rose. For example, in Palm Springs, Calif., more than 90% of the winds come from a sector of about 10 degrees only. By building a wind turbine, optimized for winds from only a range of directions, significant savings and other benefits can be achieved.

One embodiment of the invention is a horizontal axis wind turbine, comprising a tower, a nacelle, attached at the top of the tower, an electrical generator, housed within the nacelle, a downwind rotor, attached to the nacelle; at least one guy wire, fixed at the top of the tower; a yawing device allowing the nacelle to horizontally rotate within a limited sector, which is selected in such way as to prevent collision of the rotor with the guy wire. The yawing device can be passive or active. Another embodiment is a method of selecting a site of such wind turbine and of placing the guy wires on the side of the wind and the yaw sector on the opposite side, in respect to the tower.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

The accompanying drawings illustrate the invention. The illustrations omit details not necessary for understanding of the invention, or obvious to one skilled in the art, and show parts out of proportion for clarity. In such drawings:

FIG. 1A A side view of a wind turbine, guyed on one side, in one embodiment of the invention

FIG. 1B A top view of the same

FIG. 2 A sectional view of yawing device

FIG. 3A A side view of a wind turbine, guyed on one side, in another embodiment of the invention

FIG. 3B A top view of the same

FIG. 4 A side view of a wind turbine, guyed on one side, in one more embodiment of the invention

FIG. 5 A side view of a wind turbine with a hubcelle, in another embodiment of the invention

FIG. 6 Schematic view of a wind farm in another aspect of the invention

FIG. 7 Perspective view of a tower section with aerodynamic shells in another aspect of the invention

FIG. 8 Sectional view of a tower section with an aerodynamic shell

### DETAILED DESCRIPTION OF THE PREFERRED EMBODIMENTS

### Embodiment AA

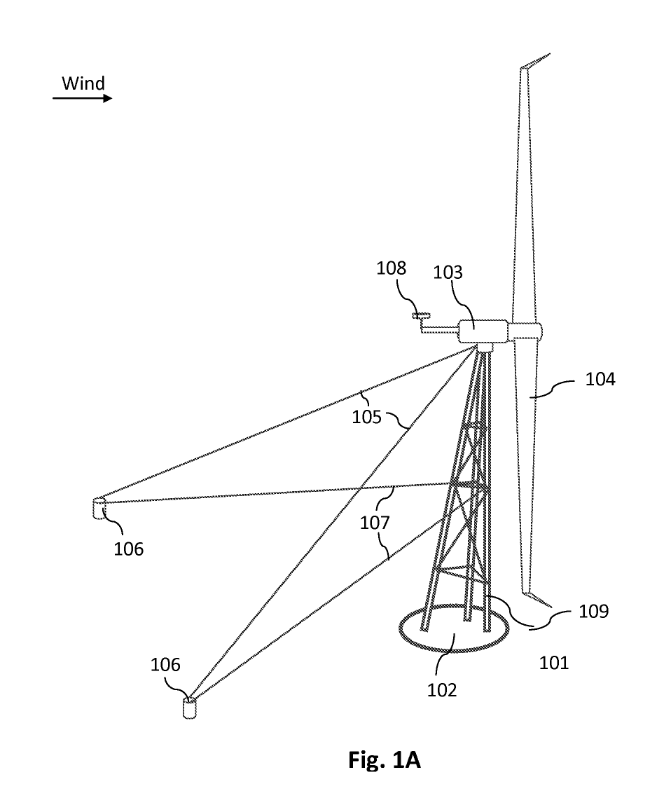

FIG. 1A shows one embodiment of the invention, designed for sites, where most of the useful wind energy comes from a sector of 90 degrees or less. It comprises a lattice tower 101, installed on a concrete foundation 102. A nacelle 103, connected to a hub of a rotor, comprising one or more blades 104 are installed on top of lattice tower 101 in a downwind configuration. Nacelle 103 contains electrical generator and other usual mechanisms. Two guy wires 105 are attached to the top of lattice tower 101 on one end and to ground anchors 106 on other ends. There might be additional guy wires 107, attached to lattice tower 101 at lower levels. Optionally, an anemometer 108 is attached to nacelle 103 on a long spar. Optionally, blades 104 can have wingtip devices 109, such as a winglets or wingtip fences. Wingtip device 109 is pointing to downwind (or longer on the downwind side than on the upwind side) in this embodiment.

FIG. 1B shows the top view of this embodiment. The horizontal line on the sheet is drawn as axis X, and the angles will be measured relative to this axis. Axis X is in the middle of the sector of the most useful winds, selected by the practitioner (designated sector).

Guy wires 105 connected to tower 101, have their projections in the horizontal plane at 90 degrees one to another. The projections of the guy wires have angles plus or minus 135 degrees to axis X. That allows the rotor to yaw within 90 degrees sector from −45 degrees to +45 degrees without the blades hitting the guy wires. FIG. 1B shows the rotor in the middle of the sector (solid lines) and turned 45 degrees clockwise (dashed lines). Per selection, most of the useful winds are expected to come from the 90 degrees sector between guy wires 105 (designated sector). The limits of useable wind directions in the designated sector are shown in dashed arrows on the left. When the wind is from the designated sector, the turbine operates as a usual HAWT: the rotor yaws and rotates and the turbine produces energy. If the wind shifts to outside of the designated sector, the rotor stops in one of the extreme positions, the blades are pitched to feather and the rotor is stopped. When the blades are feathered and the rotor is stopped, wind forces acting on the rotor are limited to only small fraction of the forces, acting on it when the rotor rotates with full speed. Thus, large horizontal forces act on the top of the tower only in the sector from −45 to +45 degrees, and are compensated by the guy wires 105. Horizontal forces from the wind, acting on the stopped and feathered rotor and tower itself are relatively small. There is also weight of the tower and vertical component of the guy wires tension, which are efficiently resisted by tower compression. There are miscellaneous forces, which are relatively small. Tower 101 is designed to resist them. That requires much lighter tower, than would be required to resist horizontal forces, acting on the rotor in the full motion. Further, guy wires 105 and 107 dampen vibrations of the tower.

The top of the tower does not mean only the exact point at the top. As used here, this term include near the top or as far as ⅙th rotor's diameter from the top. Also, guy wires 105 and 107 can be attached directly to nacelle 103.

One or more anemometers 108 can be connected to a control system of the turbine. Because the anemometers are far upwind, they notify of changes in the wind some time before they hit the blades, and the control system adjusts yaw of the rotor, pitch of the blades and other controlled parameters correspondingly. This increases efficiency and decreases dangerous loads on the blades.

Wingtip device 109 serves to reduce turbulent vortices, providing the following benefits: lower noise, less impact on the downwind turbines in a wind farm, higher aerodynamic efficiency and energy production for the same rotor diameter. This embodiment allows installation of large winglets, pointing to the side of wing with lower pressure, without danger of hitting the tower.

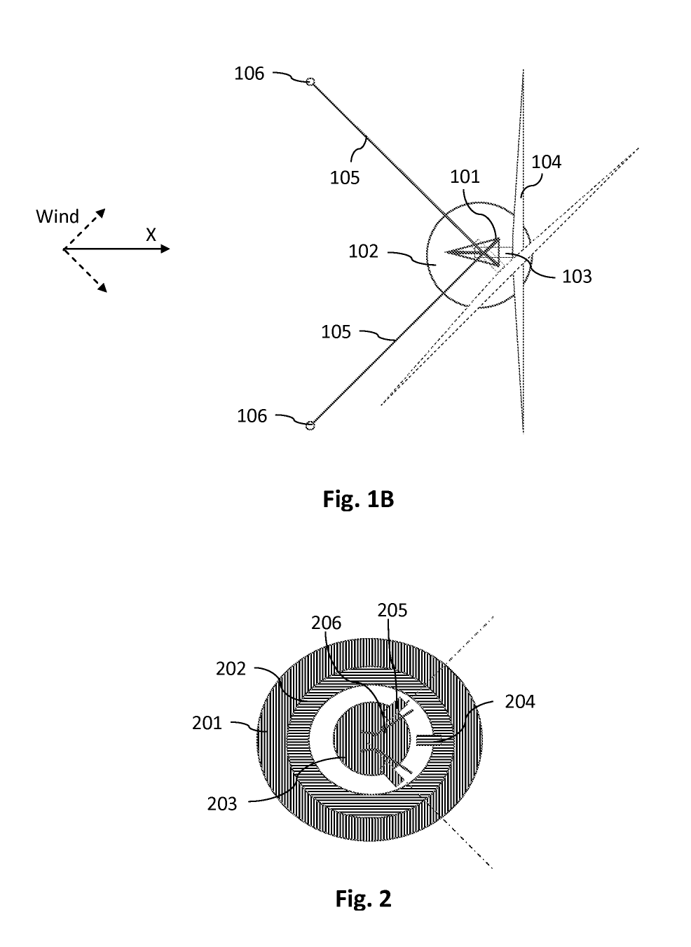

FIG. 2 shows possible implementation of the yaw subsystem for the embodiment above. It comprises a fixed external ring 201, a rotating ring 202, carrying the nacelle and the rotor and an internal fixed ring 203. Rotating ring 202 has a protrusion 204, while the internal ring has two protrusions 205, delimiting sector of 90 degrees. Additionally, there are spring dampers 206. The yaw subsystem may be active (having an electronic control system and an engine) or passive. Normally, the electronic control system in the active yaw ensures that the ring rotates within its allocated 90 degrees. If it fails to do that, or the passive yaw is used, protrusions 205 limit rotation of rotating ring 202 by stopping protrusion 204. Spring dampers 206 brake the yaw movement and dissipate rotational energy when rotating ring 202 approaches the stop points.

To select a site that is suitable for this embodiment of the invention and/or to select the designated sector, the practitioner should use history of the winds on a proposed site and consider electrical power that can be produced from those winds. The function P(v) of power from the wind speed is specific for each turbine design, but for most modern turbines it can be described as follows:

```
IF (v < V₀) THEN
    P(v) = 0
ELSE IF (v < Vₙ)
    P(v) = c*v³
ELSE IF (v < Vₘₐₓ)
    P(v) = c*Vₙ³
ELSE
    P(v) = 0
ENDIF
```

The turbine does not produce energy at wind speed below certain minimum V₀ (cut in speed), which is typically 4-5 m/s. Above that, the power produced grows proportionally to the cube of the wind speed up to certain wind speed Vₙ, corresponding to the nameplate power of the turbine. Vₙ is typically 12-15 m/s. After that, power produced remains constant up to the cut off wind speed Vₘₐₓ, at which speed rotor is stopped and the power output drops to 0. Vₘₐₓ is typically around 25 m/s. Thus, the practitioner would create a rose of powers P(v) instead of the rose of winds and use it for visualizing and selecting a 90 degrees sector with maximum power output. This selection is easily done on a computer, using formula above.

The practitioner can also consider economical value of the produced energy, rather than raw power output. Economical value will take in account different price of produced energy at different times of a day and a year.

### Advantages

One advantage of the embodiment, described above, compared with existing horizontal axis wind turbines (HAWT) is that guy wires eliminate most of the horizontal forces, acting on the tower. As the result, the tower becomes much lighter, less expensive and slenderer. It is less expensive to transport and to erect. It can be transported disassembled, then assembled on the ground and raised.

Because the tower is slender, it allows use of a downwind rotor. The downwind rotor has known advantages compared with the upwind rotor, the main of them is that the blades can flex in strong winds. Thus, construction of the blades can be significantly lighter and cheaper. The main problem for downwind rotor is decreased wind energy and turbulence behind the tower (aerodynamic shadow). This shadow causes dangerous vibrations in the blades. In this embodiment the tower is so slender, that it does not create significant aerodynamic shadow.

Additional advantage is that the slender tower has less visual impact on the landscape. Additional advantage is that power cable, coming from the tower, is not getting twisted, as happens on the wind turbine with unlimited yaw angle. Additional advantage is use of anemometer to predict wind pressure on the blades and apply corrective actions. Additional advantage is ability to use large winglets on the downwind side of the blade (i.e. side with lower pressure).

### Variations

In some variations of this embodiment, a round tower can be used instead of lattice tower. In some variations, large winglets can be designed to provide variable lift force in the direction of the blade axis, with that force being smaller near the ground (because of the lower wind speed and higher turbulence) and higher at the top, thus compensating asymmetrical gravitational forces on the blade and decreasing fatigue, caused by their asymmetry.

In another embodiment, the rotor is not stopped when the wind shifts outside of the designated sector. Instead, it remains in the extreme position and is allowed to run as long as the wind is no far than 15-45 degrees outside of the designated sector. The rotor will not be perpendicular to the wind in such situation, but will still harvest substantial wind energy. In one more embodiment, the wind turbine is operational even if the wind blows from the direction, opposite to the designated sector, as long as the wind is weak enough and the blades are pitched in such way that the tower can withstand wind pressure in the direction, opposite to the normal, i.e. without resistance of the guy wires. Thus, the wind turbine will be able to generate some energy from the wind, blowing in the direction, opposite to the usual one, although only a fraction of what it would be able to generate when the wind blows from the designated sector. In this embodiment, the blades are pitched around 180 degrees and the rotor becomes upwind, when the wind blows in the direction, opposite to the designated sector.

In all embodiments described above, the tower can be asymmetrical, for example, inclined from the vertical away from the designated sector.

### Other Embodiments

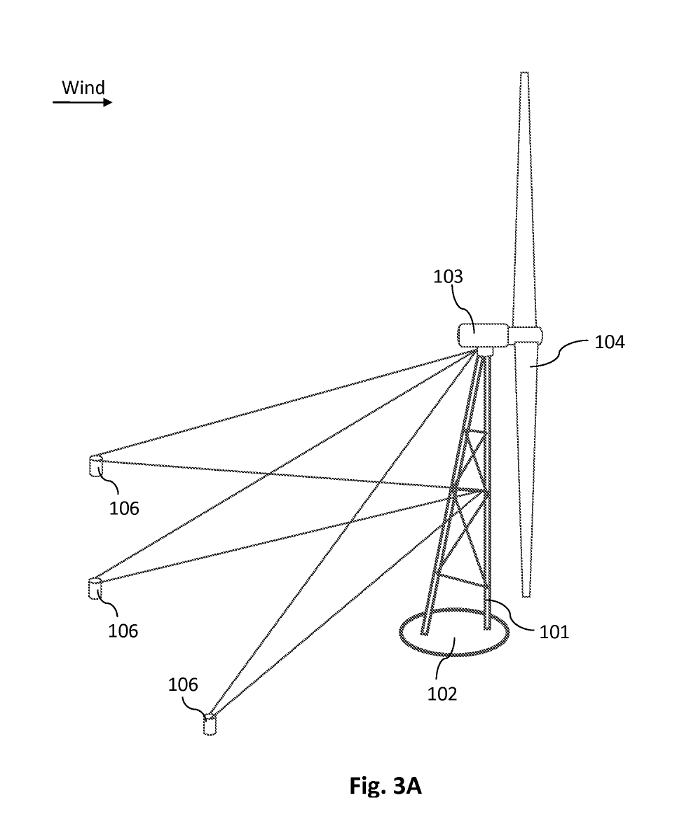

FIG. 3A and FIG. 3B show another embodiment of the invention, designed for sites, where most of the useful wind energy comes from a sector of 60 degrees or less. It allows to increase angle between guy wires to 120 degrees, and put another set of guy wires between them. At such angles, the guy wires can resist forces in wider range of directions. This allows to use even lighter towers, like two legged lattice tower with the horizontal projection along axis X, or an elliptical tower.

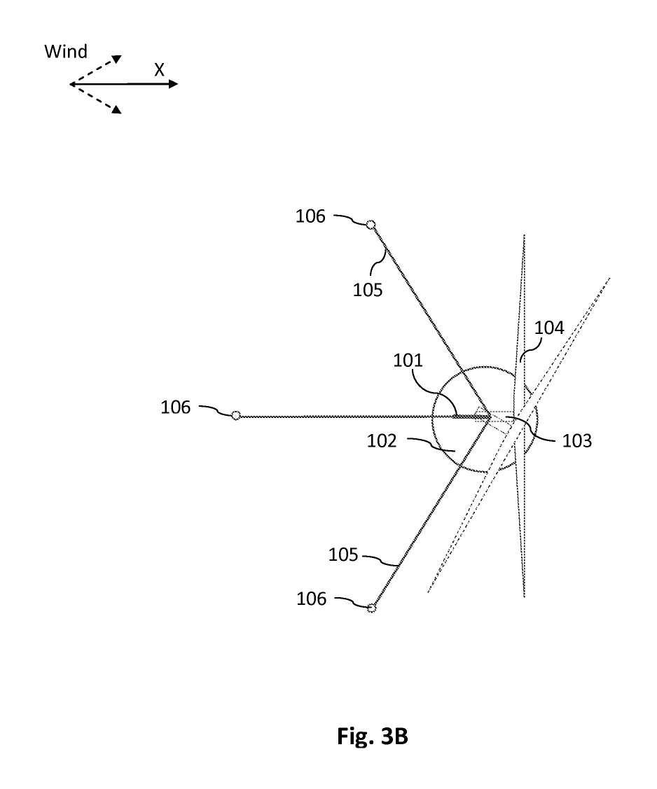

FIG. 4 shows another embodiment of the invention, designed for sites, where most of the useful wind energy comes from a sector of 60 degrees or less. It has a tower 301 in the form of a letter T. The central guy wire is attached to a closer guy wire anchor 306, and serves as a counterweight to the nacelle and the rotor, installed on the opposite side of the T. In this embodiment, the weight of the nacelle and the rotor serve to resist horizontal forces in the direction of 180 degrees. An important feature of this embodiment is that the nacelle does not have to be centered on the tower (or even serve as a counterweight to the rotor), as in existing designs.

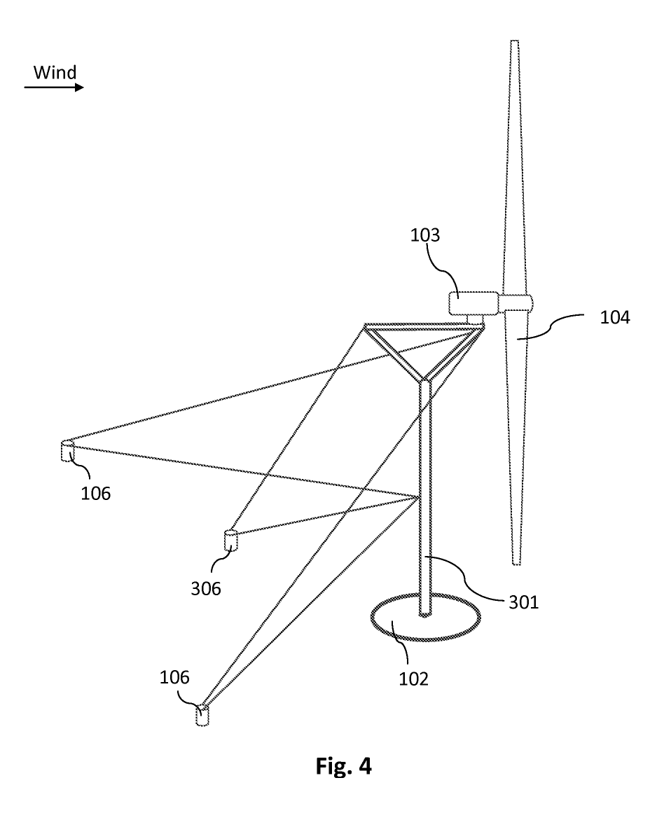

FIG. 5 shows another embodiment, in which nacelle is integrated with the hub into a single hubcelle 503. Hubcelle 503 can house a direct drive generator or a gearbox with a usual high RPM generator. In both cases, main shaft is not needed. A ring gear of the planetary gearbox or a rotor of the direct drive can be structural part of the rotating part of hubcelle 503.

Another aspect of the invention is a wind farm, utilizing horizontal axis wind turbines with limited yaw. Today, 8-15 rotor diameters is considered minimal distance between HAWTs in a wind farm. Turbines with the yaw, limited to 90 degrees, can be arranged in the rows, spaced much closer: 2-4 diameters of the rotor. This allows up to 4 times higher density of wind turbines. The rows should be perpendicular to axis X. Stricter limitations on yaw angle and/or use of winglets can decrease necessary space even more.

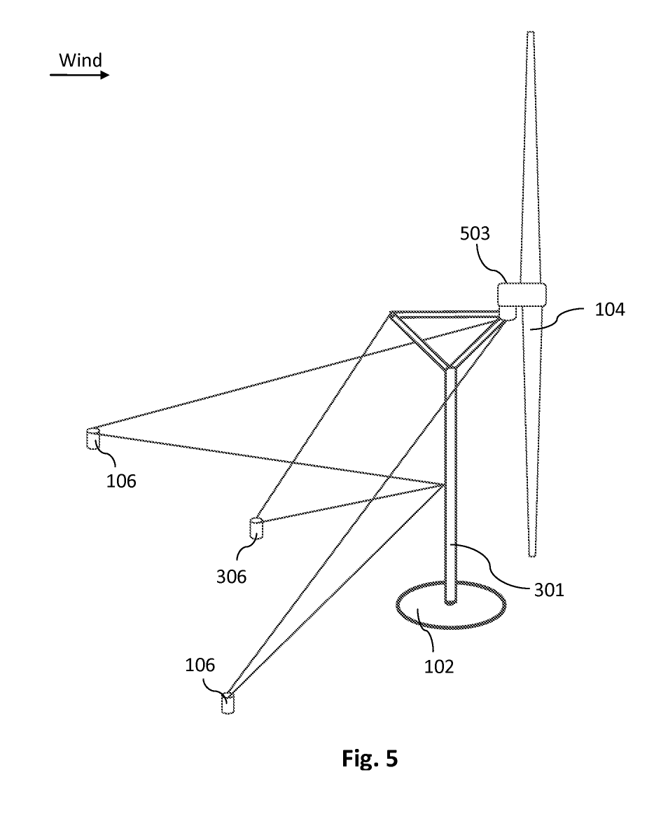

FIG. 6 shows such a turbine row. Dashed lines show limits of blade rotation. This figure shows also another aspect of the invention—use of a single wire anchor 106 for attaching guy wires of two towers.

### More Embodiments

On some sites it is not possible to select a sector from which most of wind energy comes. The following embodiment of the invention is a device that allows to decrease air flow disturbance behind the tower (“tower shadow”) and use downwind rotor with 360 degrees yaw.

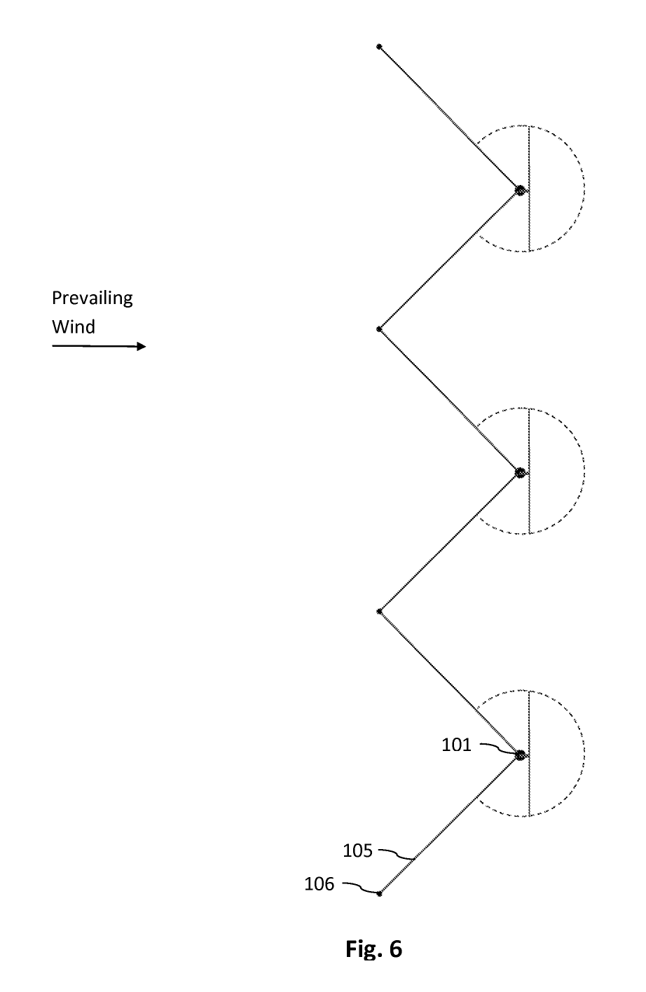

FIG. 7 shows external view of the embodiment. It consists of one or more streamlining shells 702, that are put on a round tower 701 and can freely rotate around it. Tower 701 has round rail or flange and shell 702 can glide or rotate on small rollers around it. Shell 702 together with the corresponding tower section have a symmetrical airfoil form or another streamlined form. Shell 702 can be closed—i.e., hugging its section of the tower from all sides, or it can be open—containing only front and rear parts of the airfoil, and the tower itself supplying the middle part. FIG. 7 shows mixed shells that are closed on the top and on the bottom, but open in the middle. Whether closed or open, each shell 702 has at least two rings or flanges, that ride on the tower's flanges or rails.

Pushed by the wind, shell 702 will always position itself with the airfoil front toward the wind. In this position the airfoil form drastically decreases wind turbulence and wind energy loss behind the tower. Additional benefit is decreased wind forces, acting on the tower. Each shell positions itself independently of other shells and rotor. It is possible that wind directions are different on different heights, and each shell will position itself correctly for the wind on its height.

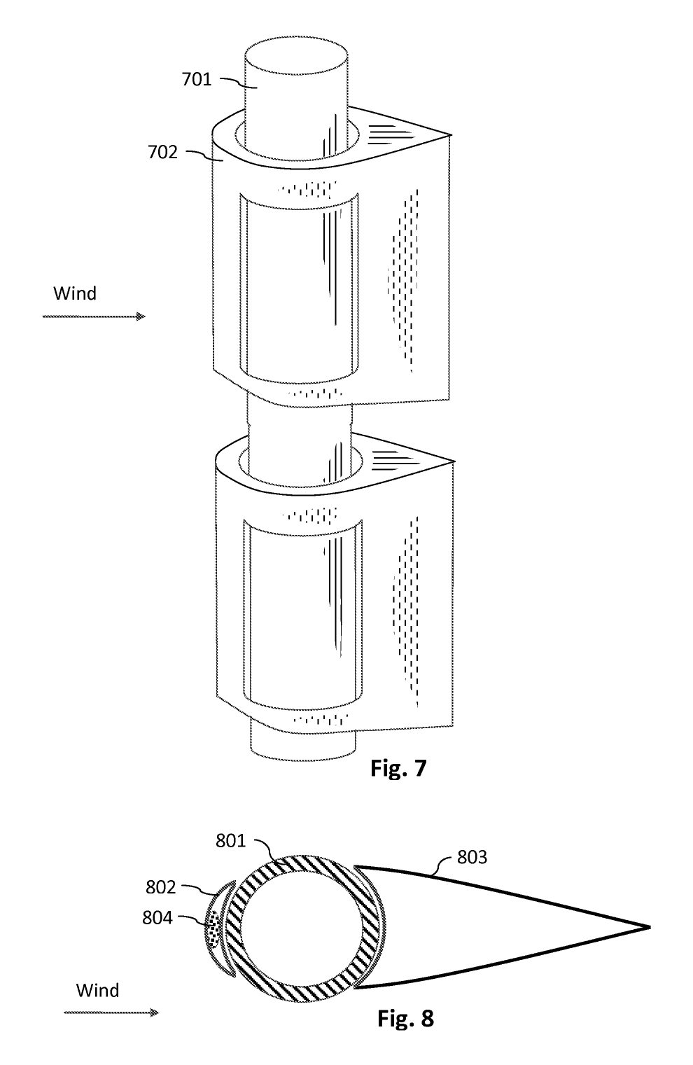

FIG. 8 shows section of the open shell (without flanges), set around the tower with round walls 801. The shell comprises a front part 802, made of fiberglass or aluminum or thin steel, a rear part 803, made of fiberglass or aluminum or thin steel, and a counterweight 804. made of steel or iron.

The embodiments, described above, can be practiced on land or offshore. When practiced offshore, the tower can be deployed on columns or on a floating structure, anchored to the bottom. The guy wires can be attached to the same or other columns or floating structures, or directly to the bottom, or to floating buoys, anchored to the bottom.

Thus, limited yaw wind turbine with methods for its deployment and its alternatives are described in conjunction with one or more specific embodiments. While above description contains many specificities, these should not be construed as limitations on the scope, but rather as exemplification of several embodiments thereof. Many other variations are possible.

What is claimed is:

1. A horizontal axis wind turbine, comprising:
a tower;
a nacelle, attached at the top of the tower;
an electrical generator, housed within the nacelle;
a downwind rotor, attached to the nacelle;
at least one guy wire, fixed at the top of the tower;
a yawing device allowing the nacelle to horizontally rotate within a limited sector;
wherein the limited sector is selected in such way as to prevent collision of the rotor with the guy wire.

2. The system of claim 1, wherein there are at least two guy wires and the limited sector has angle of 90 degrees or less.

3. The system of claim 1, wherein the limited sector is selected to be opposite to the sector of predominant winds in the location, where the system is installed.

4. The system of claim 1, further comprising a computerized control system.

5. The system of claim 1, wherein the tower has lattice construction.

6. A method of converting wind energy into electrical energy, comprising steps of:
selecting a site, where winds blow mostly from within a first sector of 90 degrees or less;
installing on this site a wind turbine, comprising
a tower;
a yawing nacelle, attached at the top of the tower;
an electrical generator, housed within the nacelle;
a downwind rotor, attached to the nacelle;
using at least one wire, permanently attached at the top of the tower and to the ground within or around the first sector to resist wind pressure, acting on the rotor.
